(19) United States
(12) Patent Application Publication
(10) Pub. No.: US 2018/0064044 A1
(43) Pub. Date: Mar. 8, 2018

(54) INDUSTRIAL HYDROPONIC CONTROL APPARATUS

(71) Applicant: Scott Billings, Tacoma, WA (US)

(72) Inventor: Scott Billings, Tacoma, WA (US)

(21) Appl. No.: 15/256,585

(22) Filed: Sep. 4, 2016

(51) Int. Cl. A01G 31/02; A01G 9/24; A01G 13/02; F25D 17/02; F25D 11/00; F25D 19/00; G06F 3/14; G05B 19/042

(52) U.S. Cl. CPC A01G 31/02; A01G 9/246; A01G 13/0243; A01G 13/0212; A01G 9/247; A01G 2031/006; F25D 11/00; F25D 19/003; G06F 3/14; G05B 19/0428; F25D 17/02

(57) ABSTRACT

An industrial hydroponic control apparatus for monitoring and modifying an environment for growing plants includes a portable table, a reservoir, a refrigerator assembly, and a control device. The portable table includes predetermined positions for mounting insulated plant containers (IPC). Each IPC supports one or more plants. The reservoir is positioned below the portable table. The reservoir is in fluid communication with each IPC to distribute a fluid to each IPC and drain the excess fluid from each IPC via a piping network. The refrigerator assembly is positioned adjacent to the reservoir and is operably engaged to the reservoir. The refrigerator assembly adjusts a temperature of the fluid within a predefined range, thereby chilling the fluid. The control device is in operable communication with the IPC, the refrigerator, and the reservoir. The control device is configured for monitoring and modifying the environment for growing the plants.

### FIELD OF THE INVENTION

The invention disclosed herein relates generally to growing plants using hydroponic gardening apparatuses. More particularly, the invention relates to a hydroponic gardening apparatus, which is portable, capable of growing plants with minimal human interaction, and capable of interfacing with horticulture tracking software.

### BACKGROUND

Hydroponics refers to the method of growing plants without soil. Instead, the plants are grown using aerated stones and fed with mineral nutrient solutions. Conventional hydroponics systems used for indoor or industrial gardening applications require skilled labor for installation. Additionally, these systems lack portability thereby reducing their utility in applications requiring frequent movement of the hydroponic gardening equipment. A hydroponic gardening apparatus, which is portable and installed with minimum effort, is required. Furthermore, existing hydroponic systems do not provide feedback to a user in the event of a component malfunctioning. Alternately, a user cannot monitor fluid levels, temperature levels, and other ambient condition levels of the hydroponic system remotely via a communications network, for example, the internet. Conventional systems, therefore, lack a ‘smart’ or ‘intelligent’ notification and monitoring feature, which enables users to grow plants using hydroponics. An apparatus, which monitors ambient condition levels for optimal growth of the plants and notifies users of a malfunction or reduction in ambient condition levels, is required.

Additionally, it is common knowledge that growing plants require different nutrients at different stages of growth. The supply of chilled water also affects the growth of the plants grown in a hydroponic apparatus. If the roots of the plant are kept highly oxygenated and slightly chilled via a nutrient solution and air temperatures are kept slightly warm, plant growth is affected positively. An apparatus, which supplies chilled nutrient-rich fluids to a plant, is required. Moreover, in climates having hot and highly humid conditions, the humidity levels have to be reduced for providing an environment conducive to optimal plant growth. For applications like these, an apparatus, which is capable of dehumidifying the air surrounding the plant growing area, is required.

Hence, there is a long felt but unresolved need for an apparatus, which monitors ambient condition levels for optimal growth of the plants and notifies users of a malfunction or reduction in ambient condition levels. Furthermore, there is a need for an apparatus, which supplies chilled nutrient-rich fluids to a plant. Moreover, there is a need for an apparatus, which is capable of dehumidifying the air surrounding the plant growing area. Additionally, there is a need for an apparatus that can interface with horticulture tracking software and records events in real time via the internet.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for an apparatus, which monitors ambient condition levels for optimal growth of the plants and notifies users of a malfunction or reduction in ambient condition levels. Furthermore, the invention disclosed herein addresses a need for an apparatus, which supplies chilled nutrient-rich fluids to a plant. Moreover, the invention addresses a need for an apparatus, which is capable of dehumidifying the air surrounding the plant growing area. Additionally, the invention addresses a need for an apparatus that can interface with horticulture tracking software and records events in real time via the internet. The industrial hydroponic control apparatus for monitoring and modifying an environment for growing plants comprises a portable table, a reservoir, a refrigerator assembly, and a control device. The portable table comprises a plurality of predetermined positions for mounting a plurality of insulated plant containers. Each insulated plant container supports one or more plants. The reservoir is positioned below the portable table. The reservoir is in fluid communication with each insulated plant container to distribute a fluid to each insulated plant container and drain the excess fluid from each insulated plant container via a piping network. The refrigerator assembly is positioned adjacent to the reservoir. Furthermore, the refrigerator assembly is operably engaged to the reservoir. The refrigerator assembly adjusts a temperature of the fluid within a predefined range, thereby chilling the fluid. In an embodiment, the refrigerator assembly comprises a dehumidifier for dehumidifying the air surrounding the plants. The control device is in operable communication with the insulated plant containers, the refrigerator, and the reservoir. The control device is configured to monitor and modify the environment for growing the plants.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of an industrial hydroponic control apparatus.

FIG. 2 exemplarily illustrates an exploded view of an industrial hydroponic control apparatus.

FIG. 3 exemplarily illustrates a top perspective view of a refrigerator assembly and a reservoir of an industrial hydroponic control apparatus.

FIG. 4A exemplarily illustrates a perspective view of an insulated plant container of an industrial hydroponic control apparatus.

FIG. 4B exemplarily illustrates a perspective view of an insulated blanket of an insulated plant container.

FIG. 5 exemplarily illustrates a perspective view of an industrial hydroponic control apparatus.

FIG. 6A exemplarily illustrates a top plan view of a piping network of an industrial hydroponic control apparatus, showing supply piping.

FIG. 6B exemplarily illustrates a top plan view of a piping network of an industrial hydroponic control apparatus, showing return piping.

FIG. 7 exemplarily illustrates a perspective view of a bi pin adapter of an industrial hydroponic control apparatus.

FIG. 8 exemplarily illustrates a schematic diagram of a control device of an industrial hydroponic control apparatus.

### DETAILED DESCRIPTION OF THE INVENTION

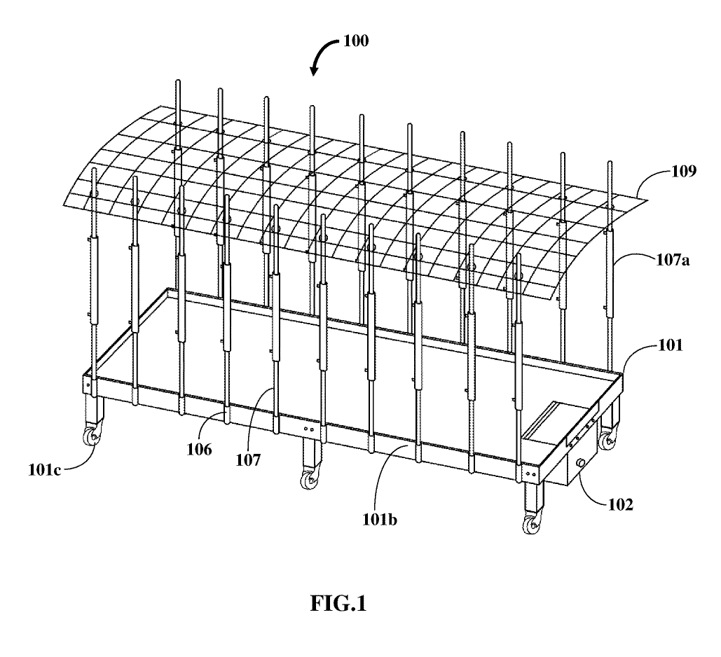

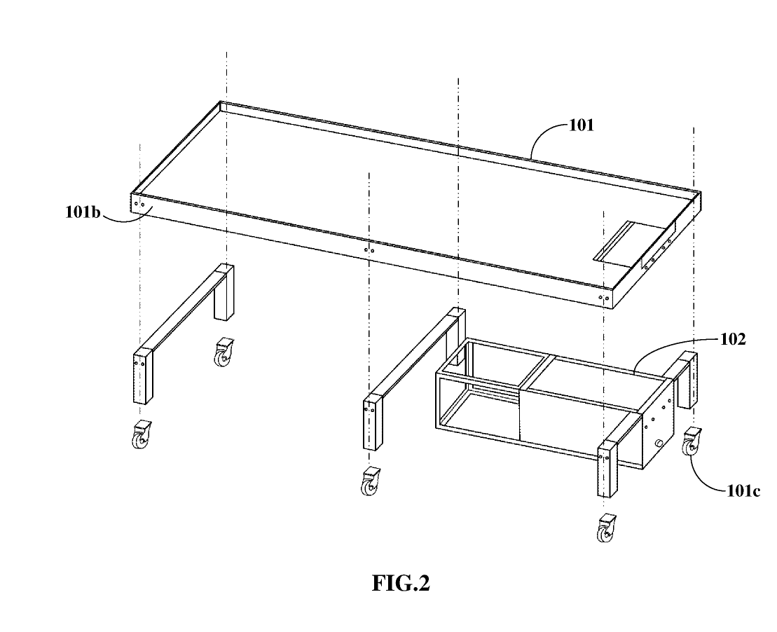

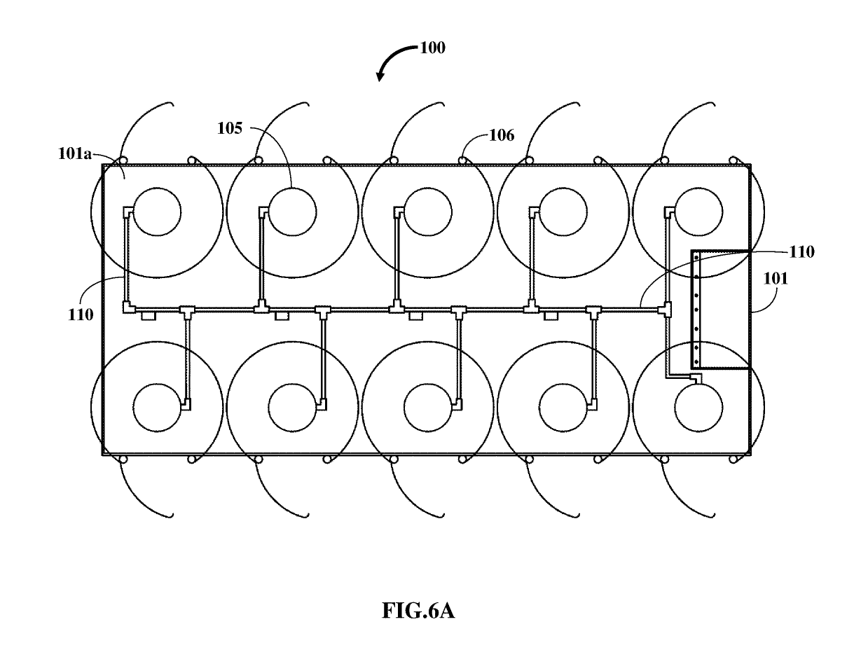

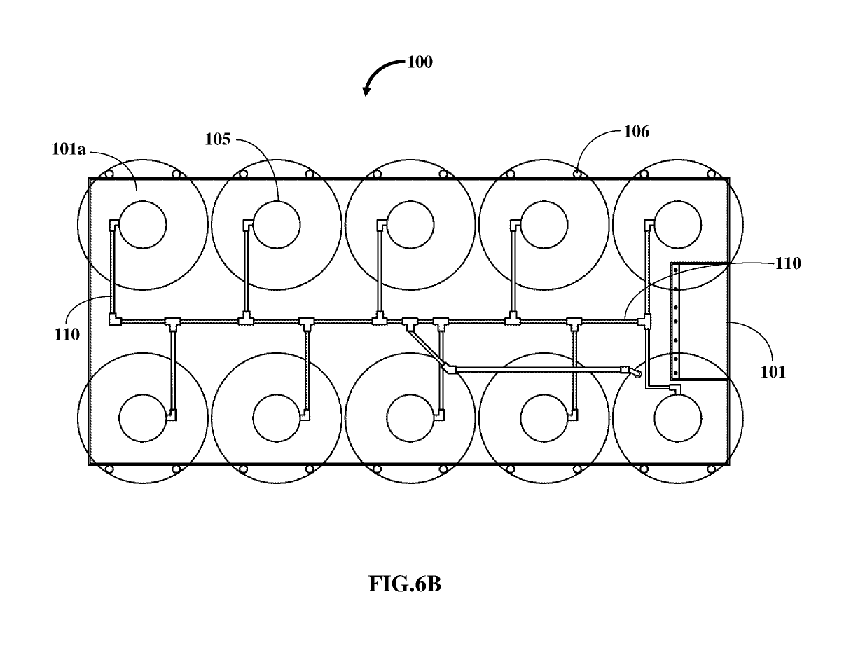

FIG. 1 exemplarily illustrates a perspective view of an industrial hydroponic control apparatus 100. FIG. 2 exemplarily illustrates an exploded view of an industrial hydroponic control apparatus. The industrial hydroponic control apparatus for monitoring and modifying an environment for growing plants comprises a portable table 101, a reservoir 102, a refrigerator assembly 103, and a control device 104 as exemplarily illustrated in FIGS. 1-8. The portable table 101 comprises predetermined positions 101a for mounting a plurality of insulated plant containers 105 exemplarily illustrated in FIG. 6. Each insulated plant container 105 supports one or more plants. The portable table 101 comprises mounting sleeves 106, vertical posts 107, circular cage members 108, and a roof cage member 109 as exemplarily illustrated in FIGS. 1, 2, 5, and 6. In an embodiment, the mounting sleeves 106 are fixedly attached to external side surfaces 101b of the portable table 101. In an embodiment, casters 101c are provided to ensure portability of the industrial hydroponic control apparatus 100. The vertical posts 107 are mounted on the mounting sleeves 106 of the portable table 101. Each vertical post 107 comprises an adjustable sleeve 107a. The roof cage member 109 is detachably attached to the vertical posts for covering the circular cage members 108. In an embodiment, the circular cage members 108 are made of a material, for example, steel mesh material, etc. Moreover, the roof cage member 109 is also made of a similar material, for example, a steel mesh material.

In an embodiment, the reservoir 102 is positioned below the portable table 101. The reservoir 102 is in fluid communication with each insulated plant container 105 to distribute a fluid to each insulated plant container 105 and drain the excess fluid from each insulated plant container 105 via a piping network 110 exemplarily illustrated in FIG. 6. In an embodiment, the refrigerator assembly 103 is positioned adjacent to the reservoir 102. In an embodiment, the refrigerator assembly 103 is operably engaged to the reservoir 102 to adjust a temperature of the fluid within a predefined range. Both the refrigerator assembly 103 and the reservoir are fixedly attached to the portable table 101 of the industrial hydroponic control apparatus 100 enabling the whole unit to be movable.

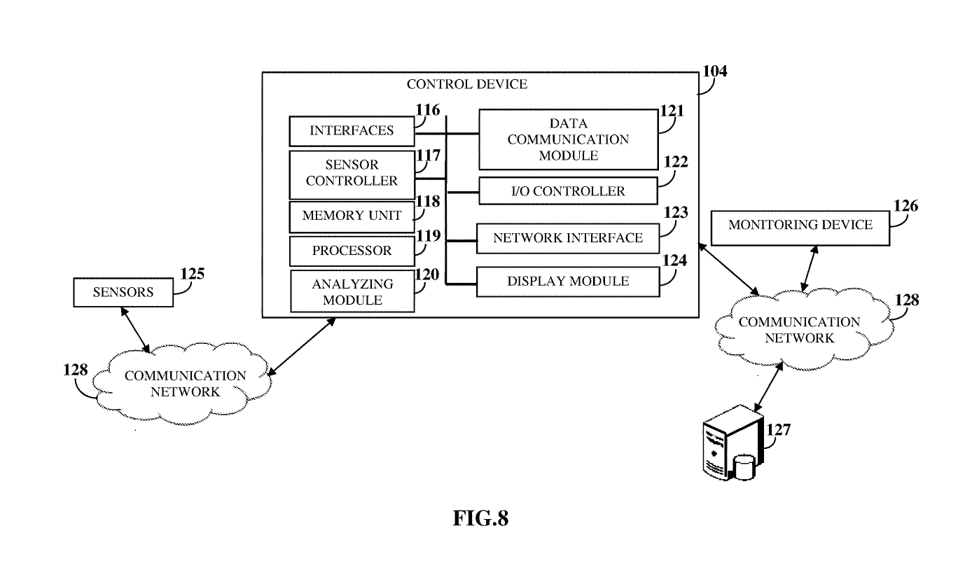

In an embodiment, the control device 104 is in operable communication with the pump and multiple sensors 125. The sensors 125, for example, flow sensors, temperature sensors, etc., are positioned on the refrigerator assembly 103 and the reservoir 102 for generating a plurality of sensor data variables. The control device 104 receives the generated sensor data variables from the sensors 125. A graphical user interface of the control device 104 displays the received sensor data variables and transmits the sensor data variables to either a server 127 or a monitoring device 126 via a communication network 128, as exemplarily illustrated in FIG. 8, for monitoring and modifying the environment for growing the plants.

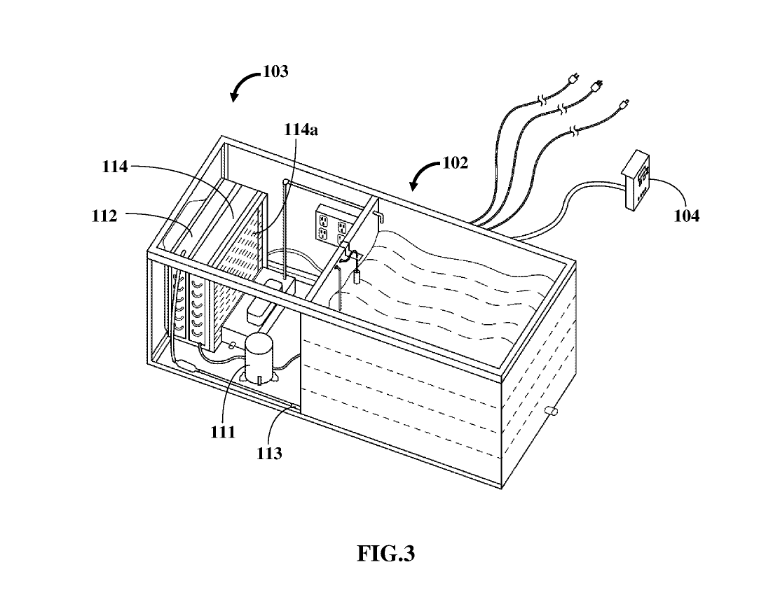

FIG. 3 exemplarily illustrates a top perspective view of a refrigerator assembly 103 and a reservoir 102 of an industrial hydroponic control apparatus 100. The refrigerator assembly 103 is positioned adjacent to the reservoir 102 as exemplarily illustrated in FIGS. 1-3. Additionally, the refrigerator assembly 103 is operably engaged to the reservoir 102 to adjust a temperature of the fluid within a predefined range. In an embodiment, the refrigerator assembly comprises a compressor 111, a condenser 112, an expansion device 113, and an evaporator 114. The compressor 111 compresses a working medium. As used herein “working medium” refers to refrigerants. A refrigerant is a substance or mixture, usually a fluid, used in a heat pump and refrigeration cycle. In most cycles, the refrigerant undergoes phase transitions from a liquid to a gas and back again. Refrigerants having favorable thermodynamic properties, noncorrosive to mechanical components, for example, non-halogenated hydrocarbons, chlorofluorocarbons, etc., are used. The condenser 112 is in fluid communication with the compressor 111 for exchanging heat of the compressed working medium with external air surrounding the condenser 112. In an embodiment, a blower or a fan is used to increase the heat transfer between the high temperature-working medium and the external air. The high temperature working medium vapor condenses to a cooled working medium liquid.

The expansion device 113 is in fluid communication with the condenser 112 and receives the cooled working medium liquid. The expansion device 113 then further lowers the pressure of the cooled working medium liquid, thereby cooling the working medium to lower temperatures. The evaporator 114 is in fluid communication with the expansion device 113 and receives the low temperature-working medium. In an embodiment, the evaporator 114 comprises multiple coiled tubing 114a through which the highly cooled working medium is passed. This increases the surface area of contact available for external warm air from the condenser 112. Since the condenser 112 is positioned in front of the evaporator 114, the external warm air surrounding the condenser 112 is cooled when the air is exposed to the coiled tubing 114a of the evaporator 114. A fan or blower is provided to increase the rate of heat transfer between the external air and the working medium. Additionally, the fluid from the reservoir 102 is also brought into contact with a few of the coiled tubing 114a of the evaporator 114. The cooled working medium exchanges heat with the fluid in the reservoir 102, thereby chilling the fluid. In an embodiment, the refrigerator assembly 103 comprises a dehumidifier for dehumidifying the air surrounding the plants. The control device in operable communication with the insulated plant containers, the refrigerator, and the reservoir, the control device is configured for monitoring and modifying the environment for growing the plants.

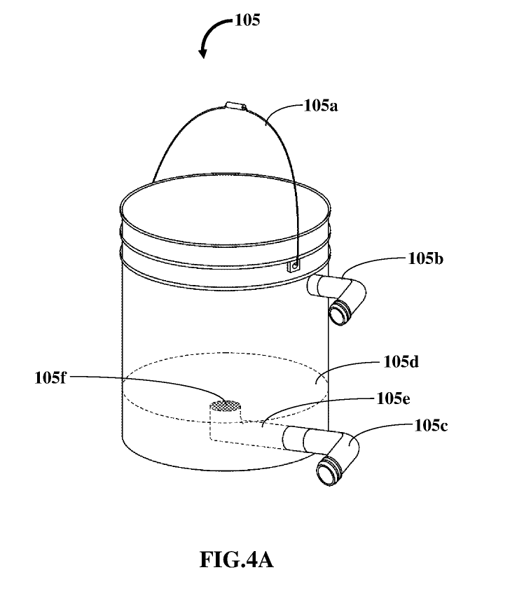

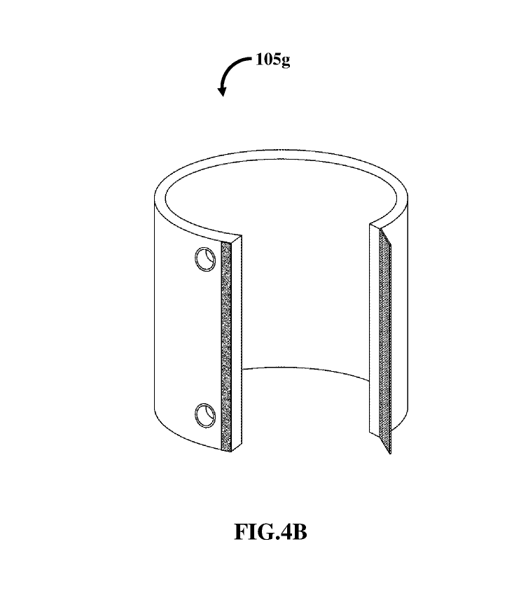

FIG. 4A exemplarily illustrates a perspective view of an insulated plant container 105 of an industrial hydroponic control apparatus 100. In an embodiment, the industrial hydroponic control apparatus 100 is designed for ten insulated plant containers 105. The insulated plant containers are positioned and evenly spaced apart along each side of the portable table 101 as exemplarily illustrated in FIGS. 6A-6B. The positions are near to the sides and near to the ends of the portable table 101 for maximum separation. The positioning also serves to maximize canopy space in the garden. In an embodiment, the insulated plant container 105 comprises a handle 105a, an inlet hose end 105b, an outlet hose end 105c, a bottom panel 105d, and a drain tube 105e as exemplarily illustrated in FIG. 4A. In an embodiment, the handle 105a is factory installed and is necessary for carrying the insulated plant container 105. A user carries or positions the insulated plant container 105 using the handle 105a of the insulated plant container 105. In an embodiment, the insulated plant container 105 is of a height of about 13 inches. The piping network 110 is connected to the inlet hose end 105b and supplies chilled fluid from the reservoir into the insulated plant container 105.

The fluid fills the insulated plant container 105 from the bottom panel 105d. In an embodiment, the bottom panel is positioned at a height of about 2 inches from the bottom of the insulated plant container 105. The bottom panel 105d further comprises a drain port 105f which drains the fluid into a drain tube 105e and back to the piping network 110 via the outlet hose end 105c. In an embodiment, the insulated plant containers 105 are of a generally cylindrical configuration. The insulated plant containers 105 are formed using injection molding. Each insulated plant container 105 comes out of the mold looking very much like a typical four gallon, round, black plastic bucket. The insulated plant container 105 holds about three gallons of hydroponic medium. The insulated plant container 105 is formed with a two-inch skirt at the bottom as exemplarily illustrated in FIG. 4A. The bottom panel 105d is designed to elevate the bottom of the insulated plant container 105 enough to recess a right angle drain tube 105e extending down in the center then across to the skirt. This formed drain tube 105e is a permanent conduit between the drain port 105f and the outlet hose end 105c.

In an embodiment, the outlet hose end 105c is a female ½-inch NPT (National Pipe Threads) recessed into the side of the bottom panel 105d. The recessed threads allow for the fitting to be removed so that the insulated plant containers 105 can be stacked for shipping or storage. In addition, the threaded fitting is necessary for cleaning, or theoretically to clear a clog in the line. The plumbing system is designed with a choke point at the ports, meaning any debris small enough to get thru the port will flush out the other end of the assembled line. The inlet hose end 105b and the outlet hose end 105c are vertically aligned with each other on the right hand side of the insulated plant container 105 as exemplarily illustrated in FIG. 4A. Each insulated plant container 105 comprises an insulated blanket 105g designed to wrap tightly around the insulated plant container 105 for insulation as exemplarily illustrated in FIG. 4B. Also included is a keeper ring that is designed to hold in place a bug barrier fabric, a pair of adopter fittings, a pair of screens and a ½″×2″ PVC supply extension nipple. In an embodiment, the keeper ring is made of a stiff, stainless steel, or galvanized steel wire that exhibits an outward spring action when installed inside of the insulated plant container 105.

The keeper ring secures a bug barrier fabric (weed block) laid over the top of the growing medium firmly against the inside of the insulated plant container 105. The keeper ring also prevents gnats and root aphids from getting into the grow stones. Once bugs enter the growing medium, it is virtually impossible to eradicate them and they can devastate a crop. A breathable fabric will not restrict air from getting to the roots when the hydro solution is not flowing. It is sliced from one side to the center allowing for easy installation and it will expand with the stalk as it grows. The screen 105h is made of an oval shaped piece of ¼″ galvanized steel mesh material. The screen 105h prevents the grow stones from getting out of the insulated plant container 105 and into the plumbing lines. The screen 105h is simply wedged into the mouth of either the inlet hose end 105b, the drain port 105f or the outlet hose end 105c, which allows the interior of the insulated plant container 105 to remain completely smooth and easy to clean. Other screens require retainer formations that are very difficult to clean and makes storage difficult for the insulated plant containers 105.

The screen 105h is easy to install by simply inserting it into the mouth of the drain port 105f. The screen 105h keeps the mouth of the drain port 105f clear of debris, the right angle of the drain port 105f prevents the screen 105h from being stuck in the line, and the choke point actually makes it easier for the pump to fill the insulated plant containers 105. In an embodiment, Teflon® tape of the CHEMOURS COMPANY FC, LLC is used on all threaded fittings to form a watertight seal.

FIG. 4B exemplarily illustrates a perspective view of an insulated blanket 105g of an insulated plant container 105. The insulated plant containers 105 are insulated using a thermal insulation material for thermally sealing the fluid in the insulated plant containers 105 to prevent unnecessary heat transfer between the fluid and surrounding air. In an embodiment, the insulation blanket 105g is made of a 1-inch thick flexible foam insulation material protected by a waterproof silicone cloth jacket. The insulation blanket 105g is made to wrap tightly around the insulated plant container 105 described below in the same fashion that the plumbing pipes are insulated. The insulated plant container 105 has two pre-punched holes to fit over the inlet hose end 105b and the outlet hose end 105c, and is be installed in seconds. The insulation blanket 105g comprises hook and loop fasteners, for example, Velcro® of Velcro Industries B.V. LLC positioned at the seam of the insulation blanket 105g. The insulation blanket 105g extends from the bottom of the insulated plant container 105 to just above the inlet hose end 105b leaving the top two inches of the insulated plant container 105 un-insulated. The insulation is designed to protect the chilled solution and roots of the plant from the heat of the environment. The insulation blanket 105g is easily removed for cleaning the insulated plant container 105. The insulated plant container 105 is also convenient for shipping and storage because removing the insulation blanket 105g and the inlet hose end 105b and the outlet hose end 105c allows the insulated plant containers 105 to be stacked together which would not be possible with a sprayed-on insulation.

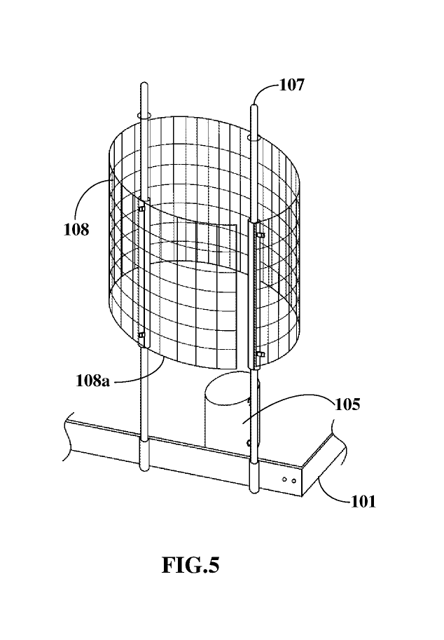

FIG. 5 exemplarily illustrates a perspective view of a circular cage member 108 of an industrial hydroponic control apparatus 100. Each circular cage member 108 comprises an access door 108a. The circular cage member 108 is detachably attached to the adjustable sleeve 107a of the vertical post 107 for adjustably positioning the circular cage member 108 on the vertical post 107 as exemplarily illustrated in FIGS. 1 and 5. The circular cage member 108 encloses the insulated plant container 105 positioned on the portable table 101 of the industrial hydroponic control apparatus 100. In an embodiment, the circular cage member 108 is made of a mesh material, for example, a steel mesh material.

FIG. 6A exemplarily illustrates a top plan view of a piping network 110 of an industrial hydroponic control apparatus 100, showing supply piping. FIG. 6B exemplarily illustrates a top plan view of a piping network 110 of an industrial hydroponic control apparatus 100, showing return piping. As disclosed in the detailed description of FIGS. 1-2, the industrial hydroponic control apparatus 100 for monitoring and modifying an environment for growing plants comprises the portable table 101, the reservoir 102, the refrigerator assembly 103, and the control device 104. The portable table 101 comprises predetermined positions 101a for mounting insulated plant containers 105 as exemplarily illustrated in FIGS. 6A-6B. Each circular cage member 108 encloses an insulated plant container 105. The circular cage members 108 are shown open in FIG. 6A. The insulated plant containers 105 are accessed by opening the door of the circular cage member 108. The reservoir 102 is positioned below the portable table 101. The reservoir 102 is in fluid communication with each insulated plant container 105 to distribute a fluid to each insulated plant container 105 and drain the excess fluid from each insulated plant container 105 via the piping network 110, thereby chilling the fluid. In an embodiment, the piping network 110 is made of a plastic material, for example, polyvinylchloride (PVC), etc.

In an embodiment, the supply and return piping are two separate trunk lines and are injection molded using black plastic. In an embodiment, the piping are assembled using ¾ inch, 200 PSI, PVC (for the return) and ¾ inch CPVC (for the supply). The trunk lines are factory assembled and then installed on site. They are installed lengthwise down the center of the table and clamped to (Unistrut) stand-offs that are mounted perpendicular to the top of the platform. The stand-offs are also tall enough to attach more pipes if necessary. Both trunk lines will have a clean out fitting at each end. The trunk lines are assembled using a combination of tees and 90 degree slip fittings that are glued together. These fittings are aimed horizontally toward the edge of the table and are appropriately aligned with each container position. These fittings are used to glue in hose whips that are specific to the supply and return fittings on each insulated plant container 105. These hose whips are cut to length and are connected directly to their corresponding fittings on each insulated plant container 105. They are made of a semi-flexible, ½ inch, black hose and each hose whip is equipped with a Female Hose End. The female hose ends contain a typical rubber O-ring for a watertight seal. The hose connectors make it very easy to connect and disconnect the insulated plant containers 105.

In an embodiment, the supply line is installed first, and is clamped to the stand-offs down as low as it can go, or about ¼″ above the platform. The supply line must be lower in elevation than the supply fitting on the insulated plant container 105 to allow the solution in the insulated plant container 105 to completely drain back into the reservoir 102 when the pump is shut off. Foam plumbing pipe insulation is provided to completely insulate the supply and return lines after they are installed. In an embodiment, the return trunk line is clamped to the same stand offs, elevating it approximately 2″ above the supply line allowing room for the foam insulation. To maintain an even flow rate, the return trunk line will tee in the middle of the system where it extends towards the left hand side of the table and takes compound angles (over and down) toward the oval shaped opening above the reservoir 102 as exemplarily illustrated in FIG. 6B. The reservoir 102 is equipped with a Flow Sensor just inside the reservoir 102 that is connected to the control device 104 and will trigger an alarm if not activated accordingly to the flow schedule. Knowing that the solution is flowing properly is of the upmost concern for hydroponic gardeners.

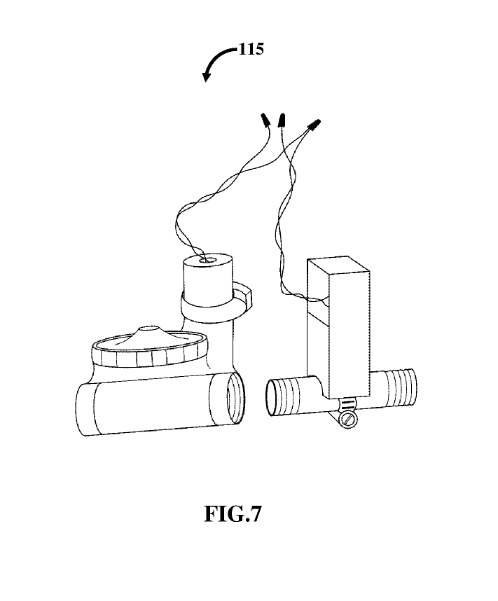

FIG. 7 exemplarily illustrates a perspective view of a bi pin adapter 115 of an industrial hydroponic control apparatus 100.

FIG. 8 exemplarily illustrates a schematic diagram of a control device 104 of an industrial hydroponic control apparatus 100. In an embodiment, the control device 104 comprises one or more interfaces 116, a sensor controller 117, a memory unit 118, at least one processor 119, an analyzing module 120, a data communication module 121, an I/O controller 122, a network interface 123, and a display module 124. The memory unit 118 is configured to store the generated sensor data variables. The processor 119 is communicatively coupled to the memory unit 118. The processor 119 is configured to execute computer program instructions defined by modules of the control device 104. The data communication module 121 is configured to receive the generated sensor data variables from the sensors 125. The analyzing module 120 is configured to dynamically analyze the received sensor data variables to recognize a state of the industrial hydroponic apparatus 100 based on previously stored sensor data variables retrieved from the memory unit 118 of the control device 104. The display module 124 is configured to display the dynamic sensor data variables on the graphical user interface of the control device 104. In an embodiment, the graphical user interface is a touch screen interface. The data communication module 121 is further configured to receive activation signals from the monitoring device 126 and transmit the received sensor data variables to either the monitoring device 126 or the server 127 via the communication network 128 for monitoring and modifying the environment for growing the plants.

The touchscreen interface of the control device 104 is used to enter data required for tracking, and for programming the refrigerator assembly 102, the circulation pump, and the de-humidifier. Once programmed, the settings are latched, meaning they remain during power loss. The control device 104 is also equipped with a small battery backup so that the time clock will keep time while the industrial hydroponic control apparatus 100 is unplugged. The control device 104 includes a digital thermometer and relative humidity display. Moreover, the control device 104 has status lights and warning lights that supervise the industrial hydroponic control apparatus 100. There are five reset buttons as well, one for GFCI protection and one for each of the four motors. They protect each motor individually, which will prevent the industrial hydroponic control apparatus 100 from shutting down due to a problem with one motor. If any sensor 125 trips, the status light changes from green to red on the control device 104 and a notification message appears on the monitoring device 105 if the monitoring device 104 is connected to the industrial hydroponic control apparatus 100 via the internet. Additionally, if the solution fails to flow during the pre-programmed period, an alarm is triggered to notify the operator.

The Built-In float switch ensures automatic re-filling of the reservoir 102. The float switch is also a low water sensor for the control device 104 of the industrial hydroponic control apparatus 100. If the float switch does not reach high level during top-off, a trouble notice will be triggered. The float switch is primarily designed to open and close the circuit to an electric (sprinkler) valve. The float switch leads are spliced to a two-wire cord with a Bi-Pin cord end on it. The cord end is necessary to maintain the portability of the industrial hydroponic control apparatus 100. The bi-pin cord plugs into the bi pin adapter 115 outlet. The bi pin adapter 115 is installed on the output side of any electric sprinkler valve where it is convenient to wire and operate. Furthermore, the bi pin adapter 115 is capable of being installed on any standard ¾″ pipe.

In an embodiment, the multiple interfaces 116 connect the sensors 125 to the control device 104. The multiple interfaces 112 are, for example, one or more bus interfaces, a wireless interface, etc. The network interface 123 connects the control device 104 to the communication network 128. As used herein, “bus interface” refers to a communication system that transfers data between components inside a computing device and between computing devices. As used herein, the “monitoring device” is an electronic device, for example, a personal computer, a tablet computing device, a mobile computer, a mobile phone, a smart phone, a portable computing device, a laptop, a personal digital assistant, a smart watch, a wearable device such as the Google Glass™ of Google Inc., the Apple Watch® of Apple Inc., etc., a touch centric device, a workstation, a server, a client device, a portable electronic device, a network enabled computing device, an interactive network enabled communication device, a gaming device, a set top box, a television, an image capture device, a web browser, combinations of multiple pieces of computing equipment, etc. In an embodiment, the electronic device is a hybrid device that combines the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing.

In an embodiment, computing equipment is used to implement applications such as media playback applications, for example, iTunes® from Apple Inc., a web browser, a mapping application, an electronic mail (email) application, a calendar application, etc. In another embodiment, computing equipment, for example, one or more servers are associated with one or more online services. In an embodiment, the sensors 125, the monitoring device 126, and the server 127 are connected to the control device 104 via a communication network 128. The communications network 128 is a network, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

In an embodiment, the sensors 125 are, for example, flow sensors, temperature sensors, etc. The sensors 102 detect temperature, flow rates, etc., of the fluid used in the industrial hydroponic control apparatus 100. The sensors 125 generate multiple sensor data variables based on the temperature, flow rate, etc., of the fluid. The memory unit 118 stores the generated sensor data variables. The processor 119 is communicatively coupled to the memory unit 118. The processor 119 is configured to execute the computer program instructions defined by the modules of the control device 104. The processor 119 refers to any one or more microprocessors, central processor (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the processor 119 is implemented as a processor set comprising, for example, a programmed microprocessor and a math or graphics co-processor. The processor 119 is selected, for example, from the Intel® processors such as the Itanium® microprocessor or the Pentium® processors, Advanced Micro Devices)(AMD® processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc.

In an embodiment, the control device 104 disclosed herein is not limited to employing a processor 119. In an embodiment, the control device 104 employs a controller or a microcontroller. The processor 119 executes the modules, for example, 120, 121, 124, etc., of the control device 104. The analyzing module 120 analyzes the generated sensor data variables to recognize a state of the fluid of the industrial hydroponic control apparatus 100 based on existing sensor data variables stored in the memory unit 114. In an embodiment, the data communications module 121 is configured to transmit the generated sensor data variables to a server 127 via the communication network 128. This enables remote access to data regarding the state of the fluid. A user may set predefined set points for the control device 104 to maintain the predefined fluid temperature, fluid flow rate, etc. In an embodiment, the graphical user interface of the monitoring device 105 provides preset options to alert the user. The notification is triggered based on crossing any one, some, or all of the predefined threshold data, for example, set minimum temperature of the fluid, set maximum flow rate of the fluid, etc. In an embodiment, the control device 104 is programmable to interface with multiple horticulture tracking software.

In an embodiment, the control device 104 of the industrial hydroponic control apparatus 100 is about twice the size of an average programmable thermostat and is designed to hang right on the front of the industrial hydroponic control apparatus 100. This minicomputer is the Central Processing Unit (CPU) for the system. The control device 104 is designed with supervisory circuits that monitor the industrial hydroponic control apparatus 100. If the industrial hydroponic control apparatus 100 is functioning properly, green lights light up on the control device 104. If there is a problem in the functioning of the industrial hydroponic control apparatus 100, the applicable status lights change from green to red in order to alert the operator. Additionally, IP (Internet Protocol) capability of the control device 104 of the industrial hydroponic control apparatus 100 allows the operator to monitor the industrial hydroponic control apparatus 100 over the internet the same way they monitor their surveillance cameras, only bandwidth is not an issue.

The foregoing examples have been provided merely for the purpose of explanation and are in no way to be construed as limiting of the industrial hydroponic control apparatus 100, disclosed herein. While the industrial hydroponic control apparatus 100 has been described with reference to various embodiments, it is understood that the words, which have been used herein, are words of description and illustration, rather than words of limitation. Further, although the industrial hydroponic control apparatus 100, has been described herein with reference to particular means, materials, and embodiments, the industrial hydroponic control apparatus 100 is not intended to be limited to the particulars disclosed herein; rather, the industrial hydroponic control apparatus 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the industrial hydroponic control apparatus 100 disclosed herein in their aspects.

I claim:

1. An industrial hydroponic control apparatus for monitoring and modifying an environment for growing plants, the industrial hydroponic control apparatus comprising:
a portable table comprising a plurality of predetermined positions for mounting a plurality of insulated plant containers, wherein each insulated plant container supports one or more plants;
a reservoir positioned below the portable table, wherein the reservoir is in fluid communication with each insulated plant container via a pump to distribute a fluid to each insulated plant container and draining the excess fluid from each insulated plant container via a piping network;
a refrigerator assembly positioned adjacent to the reservoir and operably engaged to the reservoir to adjust a temperature of the fluid and external air within a predefined range, thereby chilling the fluid and external air; and
a control device in operable communication with the pump and a plurality of sensors, the sensors positioned on the refrigerator assembly and the reservoir for generating a plurality of sensor data variables, wherein the control device receives the generated sensor data variables from the sensors, wherein a graphical user interface displays the received sensor data variables, and wherein the control device transmits the sensor data variables to one of a server and a monitoring device via a communication network for monitoring and modifying the environment for growing the plants.

2. The industrial hydroponic control apparatus of claim 1, further comprising a plurality of mounting sleeves fixedly attached to external side surfaces of the portable table.

3. The industrial hydroponic control apparatus of claim 2, further comprising vertical posts mounted on the mounting sleeves of the portable table, each vertical post comprising an adjustable sleeve.

4. The industrial hydroponic control apparatus of claim 3, further comprising circular cage members comprising access doors, each circular cage member detachably attached to the adjustable sleeve of the vertical post for adjustably positioning the circular cage member on the vertical post.

5. The industrial hydroponic control apparatus of claim 4, further comprising a roof cage member detachably attached to the vertical posts for covering the circular cage members.

6. The industrial hydroponic control apparatus of claim 5, wherein the insulated plant containers are enclosed by the circular cage members.

7. The industrial hydroponic control apparatus of claim 1, wherein the insulated plant containers are of a cylindrical configuration comprising an insulated material for thermally sealing the fluid in the insulated plant containers.

8. The industrial hydroponic control apparatus of claim 4, wherein the circular cage members are of a steel mesh material.

9. The industrial hydroponic control apparatus of claim 5, wherein the roof cage member is of a steel mesh material.

10. The industrial hydroponic control apparatus of claim 1, wherein the refrigerator assembly comprises:
a compressor for compressing a working medium;
a condenser in fluid communication with the compressor for exchanging heat of the compressed working medium with external air;
an expansion device in fluid communication with the condenser, wherein the expansion device achieves a pressure reduction in the working medium, thereby cooling the working medium; and
an evaporator in fluid communication with the expansion device, wherein the cooled working medium exchanges heat with the fluid received from the reservoir and external air, thereby chilling the fluid and external air.

11. The industrial hydroponic control apparatus of claim 10, wherein the working medium is a refrigerant.

12. The industrial hydroponic control apparatus of claim 10, further comprising a dehumidifier for dehumidifying external air surrounding the insulated plant containers.

13. The industrial hydroponic control apparatus of claim 1, wherein the control device comprises:
a non-transitory computer readable storage medium configured to store the generated sensor data variables; and
at least one processor communicatively coupled to the non-transitory computer readable storage medium, the at least one processor configured to execute computer program instructions defined by modules of the control device, the modules of the control device comprising:
a data communication module configured to receive the generated sensor data variables from the sensors;
an analyzing module configured to dynamically analyze the received sensor data variables to recognize a state of the industrial hydroponic apparatus based on previously stored sensor data variables retrieved from the non-transitory computer readable storage medium;
a display module configured to display the dynamic sensor data variables on the graphical user interface of the control device; and
the data communication module further configured to receive activation signals from the monitoring device, wherein the data communication module transmits the sensor data variables to one of the monitoring device and the server via the communication network for monitoring and modifying the environment for growing the plants.

14. The industrial hydroponic control apparatus of claim 13, wherein the graphical user interface is a touch screen interface.

15. The industrial hydroponic control apparatus of claim 13, wherein the sensors are one of flow sensors and temperature sensors.

16. The industrial hydroponic control apparatus of claim 13, wherein the monitoring device is one of a smart phone, a laptop, a tablet, and a personal computer.

17. An industrial hydroponic control apparatus for monitoring and modifying an environment for growing plants, the industrial hydroponic control apparatus comprising:
a portable table comprising a plurality of predetermined positions for mounting a plurality of insulated plant containers, wherein each insulated plant container supports one or more plants, the portable table comprising:
a plurality of mounting sleeves fixedly attached to external side surfaces of the portable table;
vertical posts mounted on the mounting sleeves of the portable table, each vertical post comprising an adjustable sleeve;
circular cage members comprising access doors, each circular cage member detachably attached to the adjustable sleeve of the vertical post for adjustably positioning the circular cage member on the vertical post, wherein the circular cage member encloses the insulated plant container; and
a roof cage member detachably attached to the vertical posts for covering the circular cage members.
a reservoir positioned below the portable table, wherein the reservoir is in fluid communication with each insulated plant container via a pump to distribute a fluid to each insulated plant container and draining the excess fluid from each insulated plant container via a piping network;
a refrigerator assembly positioned adjacent to the reservoir and operably engaged to the reservoir to adjust a temperature of the fluid within a predefined range comprising:
a compressor for compressing a working medium;
a condenser in fluid communication with the compressor for exchanging heat of the compressed working medium with external air;
an expansion device in fluid communication with the condenser, wherein the expansion device achieves a pressure reduction in the working medium, thereby cooling the working medium;
an evaporator in fluid communication with the expansion device, wherein the cooled working medium exchanges heat with the fluid received from the reservoir and external air, thereby chilling the fluid and external air; and
a control device in operable communication with the pump and a plurality of sensors, the sensors positioned on the refrigerator assembly and the reservoir for generating a plurality of sensor data variables, wherein the control device comprises:
a non-transitory computer readable storage medium configured to store the generated sensor data variables; and
at least one processor communicatively coupled to the non-transitory computer readable storage medium, the at least one processor configured to execute computer program instructions defined by modules of the control device, the modules of the control device comprising:
a data communication module configured to receive the generated sensor data variables from the sensors;
an analyzing module configured to dynamically analyze the received sensor data variables to recognize a state of the industrial hydroponic apparatus based on previously stored sensor data variables retrieved from the non-transitory computer readable storage medium;
a display module configured to display the dynamic sensor data variables on the graphical user interface of the control device; and
the data communication module further configured to receive activation signals from the monitoring device, wherein the data communication module transmits the sensor data variables to one of the monitoring device and the server via the communication network for monitoring and modifying the environment for growing the plants.
